(19) United States
(12) Patent Application Publication
(10) Pub. No.: US 2005/0108114 A1
(43) Pub. Date: May 19, 2005

(54) Inventory replenishment notification system

(76) Inventor: Ned A. Kaled, Broken Arrow, OK (US)

Correspondence Address: HONEYWELL INTERNATIONAL, INC., Law Dept. AB2, P.O. Box 2245, Morristown, NJ, 07962-9806, US

(21) Appl. No.: 10/716,926

(22) Filed: Nov. 18, 2003

(51) Int. Cl. G06F 17/60

(52) U.S. Cl. 705/28

(57) ABSTRACT

A system and method is provided for inventory replenishment notification. The inventory replenishment system includes a plurality of bin monitors. Each of the bin monitors is coupled to one of plurality of inventory storage devices, with each of the plurality of inventory storage devices including a primary bin and a reserve bin. Each of the bin monitors includes a sensor and a transmitter. The sensor monitors for when the reserve bin is accessed to replenish the primary bin. The transmitter sends this bin replenishment information to an inventory control system. The inventory control system can then automate the ordering of replacement inventory to replenish the reserve bin. Thus, the inventory replenishment notification system can ensure that sufficient inventory is always available at the inventory storage device.

### FIELD OF THE INVENTION

This invention generally relates to inventory systems, and more specifically relates to inventory replenishment.

### BACKGROUND OF THE INVENTION

Modern inventory systems can be exceedingly complex. For example, in the manufacturing of complex systems an inventory system may be needed to account for thousands of different types of parts and other components. During manufacturing the inventory of these components must be tracked to assure that sufficient numbers of components are available at all times. The shear number of components and the rates at which components are used can make tracking the inventory of components an exceedingly complex task.

Furthermore, in some large facilitates the manufacturing is spread out over a very large production area. In this case, thousands of different components can be stored in many different locations spread out over a wide area. Determining when the inventory of components needs to be replenished can thus be a tedious and time consuming job.

Typically, large production facilitates have relied upon workers to manually check the inventory status of each component by physically visiting the location where the components are stored. These workers visit the bins where the inventory is stored, check for remaining inventory, and typically enter that remaining inventory into a tracking system. In many cases, the workers must physically open the bins to determine the remaining inventory. Having the workers manually visit thousands of bins spread out over a large production area can be exceedingly costly and error prone.

Thus, what is needed is an improved system for tracking inventory usage that is spread out over a large area that offers improved efficiency and accuracy.

### BRIEF SUMMARY OF THE INVENTION

The present invention provides a system and method for inventory replenishment notification. The inventory replenishment system includes a plurality of bin monitors. Each of the plurality of bin monitors is coupled to one of plurality of inventory storage devices, with each of the plurality of inventory storage devices including a primary bin and a reserve bin. Each of the bin monitors includes a sensor and a transmitter. The sensor monitors for when the reserve bin is accessed to replenish the primary bin. The transmitter sends this bin replenishment information to an inventory control system. Based on this replenishment information, the inventory control system can then automate the ordering of replacement inventory to replenish the reserve bin. Thus, the inventory replenishment notification system can ensure that sufficient inventory is always available at the inventory storage device.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an inventory replenishment notification system;

FIG. 2 is a perspective view of a dual bin storage device with a bin monitor,

FIG. 3 is a schematic view of a second embodiment inventory replenishment system.

### DETAILED DESCRIPTION OF THE INVENTION

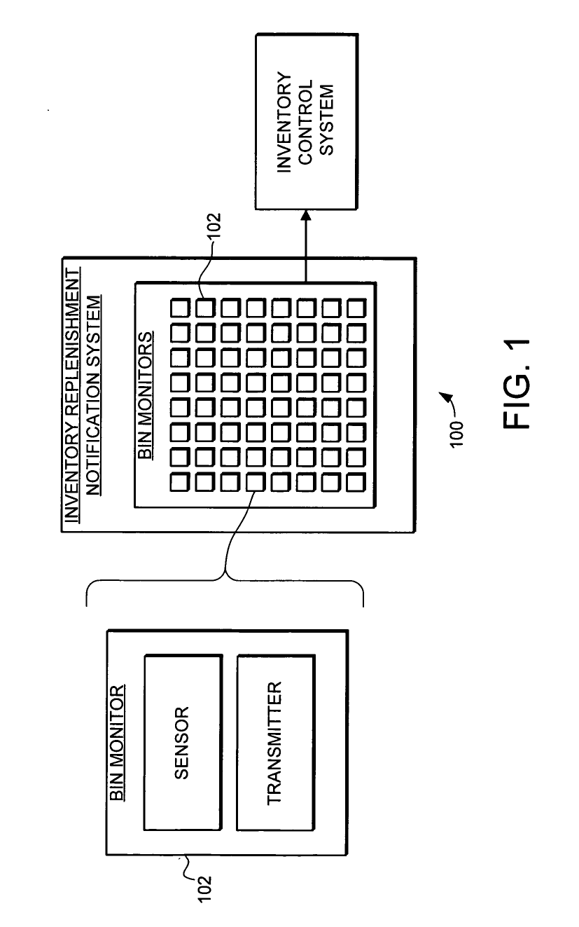

The present invention provides a system and method for inventory replenishment notification. The inventory replenishment notification system and method is designed to ensure that sufficient inventory is always available at an inventory storage device. Turning now to FIG. 1, an inventory replenishment notification system 100 is illustrated schematically. The inventory replenishment system 100 includes a plurality of bin monitors 102. Each of the bin monitors 102 is coupled to one of plurality of inventory storage devices, with each of the plurality of inventory storage devices including a primary bin and a reserve bin. Each of the bin monitors 102 includes a sensor and a transmitter. The sensor monitors for when the reserve bin is accessed to replenish the primary bin and generates replenishment information. The transmitter sends this bin replenishment information to an inventory control system. The inventory control system can then automate the ordering of replacement inventory to replenish the reserve bin. Thus, the inventory replenishment notification system 100 can ensure that sufficient inventory is always available at the inventory storage device.

The inventory replenishment notification system 100 can be implemented in a variety of different embodiments for a variety of different applications. As one example, the inventory replenishment notification system 100 is implemented for a “two-bin” inventory system. In a two-bin system, each inventory storage device in the bank of storage devices includes a primary bin and a reserve bin. The primary bin stores the current inventory of components that are being used by the workers. When the inventory has been depleted from the primary bin, a worker can access the reserve bin to repopulate the primary bin. As one example, a barrier between the reserve bin and the primary bin can be removed, causing the inventory components to transfer from the reserve bin to the primary bin, and thus repopulating the primary bin. One example of a commercially available two-bin system are inventory storage devices available from Hurst-Green Plastics, Inc.

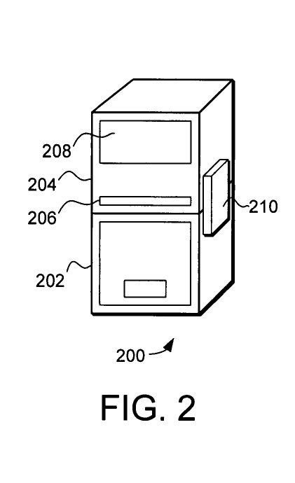

Turning now to FIG. 2, an exemplary two-bin inventory storage device 200 is illustrated. In this illustrated example, the two-bin storage device 200 includes a lower primary bin 202 and an upper reserve bin 204. During manufacturing, workers remove products from the primary bin 202 as needed by pulling out a drawer in the primary bin 202. When the inventory in the primary bin 202 is exhausted, a worker can replenish the contents of the primary bin 202 by removing a barrier 206 that separates the primary bin 202 from the reserve bin 204. Removing the barrier 206 causes the inventory in the reserve bin 204 to fall into the primary bin 202, thus repopulating the primary bin 202. At some future time, the reserve bin 204 can be refilled through an opening 208. Thus, the dual-bin storage device 200 includes a primary bin 202 storing primary inventory and a reserve bin 204 storing reserve inventory.

In accordance with the embodiments of the invention, an inventory notification system is used to provide automatic notification to an inventory system when the reserve bin 204 is accessed to repopulate the primary bin 202. Specifically, a bin monitor 210 is coupled to the two-bin storage device 200. The bin monitor 210 includes a sensor and a transmitter (not illustrated in this FIG.) The sensor in bin monitor 210 monitors for when the barrier 206 is removed to access the reserve inventory in the reserve bin 204. The transmitter in bin monitor 210 transmits this bin replenishment information to an inventory control system. The inventory control system can then automate the ordering of replacement inventory to replenish the reserve bin 204. Thus, the inventory replenishment notification system can ensure that sufficient inventory is always available at the inventory storage device 200.

In most cases it will be desirable to provide a separate, self contained bin monitor 210 for each inventory storage device. This allows the bin monitor 210 to be affixed with the inventory storage device and stay with it, even if the storage device is moved within the facility.

It should also be noted that the inventory storage device 200 is just one example of a two bin inventory storage device, and that there are many other implementations that can be used with the embodiments of the present invention. For example, the two-bin inventory storage device can use different access structures such as lids and drawers, and can be arranged in different configurations such as side to side. Finally, the two-bin inventory system can use a variety of different mechanisms to both separate the primary bin from the reserve bin, and to repopulate the primary bin when the primary bin is depleted.

The inventory replenishment notification system can be implemented in a variety of different configurations. For example, a variety of different types of sensor devices could be used to determine inventory replenishment. As another example, a variety of different transmission devices and protocols can be used to transmit the replenishment information from the bin monitors to the inventory control system.

In general, the type of sensor used would depend on the specific arrangement and type of inventory storage devices. The sensor is generally designed to determine when the reserve bin is accessed to repopulate the primary bin, and as such can be implemented with a variety of different devices, such as a variety of electrical, optical and/or magnetic devices. As specific examples, the bin monitor sensor can be implemented with motion detectors, contact switches, and similar devices. As a specific example, a contact switch can be used to determine when the barrier between the primary bin and the reserve bin has been removed to repopulate the reserve bin.

Additionally, the sensor could also be configured to monitor when the reserve bin itself is repopulated. This can be in the form of a second sensor, or by configuring a single sensor to monitor both bins.

Likewise, the transmitter used would typically depend upon the specific requirements of the implementation. The transmitter could use any type of wireless transmission, where wireless transmission is defined as communication using electromagnetic or acoustical waves through the air. In generally, a wireless transmission mechanism is selected based on needed transmission bandwidth, distance, power consumption and cost. Examples of suitable transmission devices include commercially available RF transmitters having suitable power consumption and transmission range. It should also be noted that in some situations the transmitters should be selected such that interference with other devices in the area is minimized. This can be especially important in areas such as airports where such interface is highly undesirable.

In general it is desirable to implement the bin monitors such that they can be battery powered with wireless transmission to the inventory control system. This minimizes the wiring needed and allows the monitors to be easily moved with the storage devices, something that may be required in certain applications. It also makes the bin monitor essentially self contained. To facilitate this, it will be generally desirable to design and implement the bin monitors to minimize power consumption and provide a long battery life. Additionally, it is desirable to provide the bin monitor in a durable assembly that can be easily accessed to repair and replace the batteries. The actual battery life provided will depend greatly upon the power consumption of the sensor and transmitter in the bin monitor.

As such, it is generally desirable to limit the power used by the transmitter. This can be done by limiting the distance needed to transmit to the inventory control system. In a large facility however, it may be difficult to provide the needed transmission distance without utilizing unwanted amounts of power. In such applications it may be desirable to utilize relay stations that can relay signals to and from the bin monitors. By spreading relay stations throughout the facility a large area can be covered while requiring relatively short transmission distances from the battery powered bin monitors to the relay stations.

In many applications it may be desirable to implement the relay stations to themselves use battery power to facilitate installation and movement within a facility. A relatively larger battery and transmitter in such a relay station can provide a much greater broadcast range than smaller batteries used in the bin monitors. Such a battery powered relay station could be attached to each bank of storage devices and be allowed to move with a bank of storage devices.

Thus, in one implementation a bank of storage devices can be provided with a plurality of bin monitors, with each of those bin monitors battery powered and transmitting to a battery powered relay station that is affixed to the bank of the storage devices. That relay station can then rebroadcast the information to the inventory control system. Such a system provides great flexibility and battery life while not inhibiting the movement of the bank of storage devices.

The relay stations can be implemented using any suitable devices and techniques. Again, a variety of commercially available receivers and transmitters can be used to implement the relay station. The relay stations can be configured to immediately relay information to the control system when it is received. Alternately, the relay stations could be configured to store and reconfigure the information for later broadcast.

The inventory replenishment notification system would preferably use protocols and transmission techniques that are compatible with commonly used inventory control system techniques and systems. For example, the system can be designed to interface with inventory control system programs that use commonly implemented specifications such as SPEC-2000, Electronic Data Interchange (EDI), or web-based ordering management systems. This allows the inventory replenishment system to communicate directly with the inventory system. As such, the ordering of replacement components to fill the reserve bins can be automated.

In addition to providing the ability to communicate replenishment information to the inventory control system, the transmitter can be implemented to provide two way communications to the bin monitor. The communication to and from the bin monitor can support a host of additional functionality. For example, the transmitter can be used to provide health and status information from the bin monitor to the system.

As an example, the transmitter can provide the ability for the system to periodically check the status of the storage device and the bin monitor itself. For example, the transmitter can provide the ability to notify the system of problems such as low battery power in the bin monitor. As another example, the system can be implemented to allow the bin monitors to be reconfigured and reprogrammed through the transmitter.

To fully implement the bin monitors, a programmable device would typically be used to control the operation of the sensor and the transmitter. Many different devices can be used, for example, a microcontroller, a complex programmable logic device (CPLD), a field programmable gate array (FPGA), or application specific integrated circuit (ASIC) could all be used to control the operation of the bin monitor.

In these implementations, each bin monitor preferably includes several data fields that can be accessed through the transmitter for utilization by the system. For example, each bin monitor can include data fields for component identification of the components stored in the associated bin. As another example, each bin monitor can include data fields listing the economic replenishment quantities assigned the components in the bins. Other fields can include location and platform type of the storage devices. Other fields can include the number of times the bins were accessed to create a usage history. As stated above, these data fields can be implemented to be remotely accessible through the transmitter.

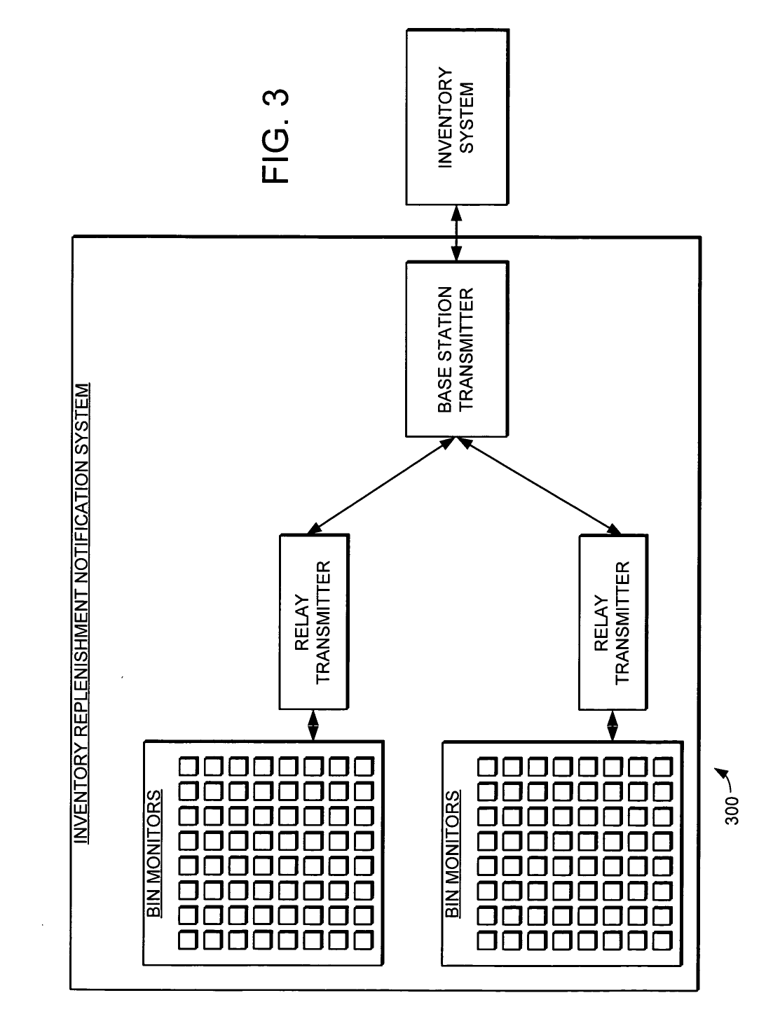

Turning now to FIG. 3, an exemplary inventory replenishment notification system 300 is illustrated. In this example, multiple banks of storage devices are monitored with the system. Specifically, in the illustrated example two banks of bins are monitored with two corresponding groups of bin monitors. Each group of bin monitors transmits to an associated relay transmitter. The relay transmitters transmit to and from a base station transmitter. The base station transmitter is then coupled to the inventory control system.

In this example, multiple banks of storage devices are monitored for replenishment information. Each relay transmitter is battery powered and can be affixed to and moved with its corresponding bank of storage devices. The base station can be a fixed transmitter coupled to any suitable computer system, such as a PC or mainframe. As such, the inventory system can be coupled to the bin monitors through the base station and relay transmitters, and the individual transmitters in each bin monitor. It can be appreciated that the system 300 can be easily expanded to cover thousands of individual bins in hundreds of separate bin banks. As such, the system 300 can provide inventory replenishment information to the inventory system without requiring manual examination by inventory management personal. Additionally, such a system does not limit that ability to move their associated banks of storage devices. The system can thus greatly improve the efficiency and accuracy of the inventory system in general, and can help avoid those disruptions that may occur when inventories are depleted.

The present invention thus provides a system and method for inventory replenishment notification. The inventory replenishment system includes a plurality of bin monitors. Each of the bin monitors is coupled to one of plurality of inventory storage devices, with each of the plurality of inventory storage devices including a primary bin and a reserve bin. Each of the bin monitors includes a sensor and a transmitter. The sensor monitors for when the reserve bin is accessed to replenish the primary bin. The transmitter sends this bin replenishment information to an inventory control system. The inventory control system can then automate the ordering of replacement inventory to replenish the reserve bin. Thus, the inventory replenishment notification system can ensure that sufficient inventory is always available at the inventory storage device.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. An inventory replenishment notification system, the notification system comprising:
a plurality of bin monitors, each of the plurality of bin monitors including a sensor and a transmitter, the sensor monitoring for when a reserve bin is accessed to replenish a primary bin, the transmitter sending bin replenishment information to an inventory control system.

2. The notification system of claim 1 wherein each of the plurality of bin monitors corresponds to one of a plurality of inventory storage devices, and wherein each of the plurality of inventory storage devices includes a primary bin and a reserve bin.

3. The notification system of claim 1 wherein the transmitter comprises a wireless transmitter.

4. The notification system of claim 1 wherein the bin monitor is powered by a battery.

5. The notification system of claim 1 wherein the transmitter comprises a wireless transmitter that transmits to a relay transmitter.

6. The notification system of claim 5 wherein the relay transmitter comprises a wireless receiver and transmitter that receives the bin replenishment information and transmits it to the inventory control system.

7. The notification system of claim 6 wherein the relay transmitter is battery powered.

8. The notification system of claim 1 wherein the inventory replenishment system automates ordering of new inventory when the bin replenishment information is received.

9. The notification system of claim 1 wherein each of the bin monitors includes a data field identifying a component type stored in the corresponding primary bin.

10. A method of updating an inventory control system for an inventory system that includes a plurality of storage devices where each of the plurality of storage devices including a primary bin and a corresponding reserve bin, the method comprising the steps of:
a) monitoring each of the plurality of inventory storage devices to determine when one of the reserve bins has been accessed to replenish its corresponding primary bin;
b) transmitting bin replenishment information to the inventory control system when the reserve bin has been accessed to replenish the corresponding primary bin.

11. The method of claim 10 wherein the step of monitoring each of the plurality of inventory storage devices comprises providing a plurality of bin monitors, each of the plurality of bin monitors coupled to one of the plurality of inventory storage devices, each of the plurality of bin monitors including a sensor and a transmitter.

12. The method of claim 10 wherein the step of monitoring each of the plurality of inventory storage devices comprises monitoring each of the plurality of inventory storage devices with a plurality of sensors, each of the plurality of sensors corresponding to one of the inventory storage devices.

13. The method of claim 12 wherein each of the plurality of sensors comprises a battery powered sensor.

14. The method of claim 10 wherein the step of transmitting bin replenishment information to the inventory control system comprises transmitting from a plurality of transmitters, with each of the plurality of transmitters corresponding to one of the plurality of inventory storage devices.

15. The method of claim 14 wherein each of the plurality of transmitters comprises a wireless transmitter.

16. The method of claim 10 wherein the step of transmitting bin replenishment information to the inventory control system comprises transmitting through a wireless transmission to a relay transmitter and re-transmitting from the relay transmitter to the inventory control system.

17. An inventory replenishment notification system, the notification system comprising:
a plurality of battery-powered bin monitors, each of the plurality of bin monitors corresponding to and coupled to one of a plurality of two-bin inventory storage devices, each of the plurality of two-bin inventory storage devices including a primary bin and a reserve bin, each of the plurality of bin monitors including a sensor and a transmitter, and wherein each sensor monitors for when its corresponding reserve bin is accessed to replenish the primary bin and generates replenishment information indicating the replenishment and wherein each transmitter sends its corresponding replenishment information to an inventory control system.

18. The notification system of claim 17 further comprising a plurality of relay transmitters and wherein each transmitter sends its corresponding replenishment information through one of the plurality of relay transmitters to a base station transmitter.

19. The notification system of claim 17 wherein each of the plurality of bin monitors can be accessed through the transmitter to determine a status of the bin monitor.

20. The notification system of claim 17 wherein each of the plurality of bin monitors includes a programmable device, the programmable device controlling the sensor and transmitter.
